(19) United States
(12) Patent Application Publication
(10) Pub. No.: US 2012/0163022 A1
(43) Pub. Date: Jun. 28, 2012

(54) ILLUMINATION APPARATUS

(75) Inventors: Levinus Pieter Bakker, Shanghai (CN); Jun She, Shanghai (CN); Hugo Johan Cornelissen, Waaire (CN); Gongming Wei, Shanghai (CN)

(73) Assignee: KONINKLIJKE PHILIPS ELECTRONICS N.V., EINDHOVEN (NL)

(21) Appl. No.: 13/376,387

(22) PCT Filed: Jun. 7, 2010
(86) PCT No.: PCT/IB2010/052502

§ 371 Date: Mar. 8, 2012

(30) Foreign Application Priority Data
Jun. 11, 2009 (CN) 200910148826.1

(51) Int. Cl. F21V 7/00; F21V 7/07; F21V 7/04; F21V 7/08; F21V 8/00; F21V 7/06

(52) U.S. Cl. 362/609; 362/608

(57) ABSTRACT

This invention relates to an illumination apparatus. The illumination apparatus comprises a light guide plate and a light source configured to emit light into the light guide plate through a first surface, and the light guide plate comprises a concentrator configured to direct incident light in the light guide plate so as to radiate in a direction substantially parallel to a preset plane. The preset plane is perpendicular to any one of the top surface and bottom surface of the light guide plate, and intersects the first surface and a second surface of the light guide plate or intersects the first surface and one of the side surfaces at an angle that is substantially larger than the critical angle of a total reflection. In this way, unwanted light loss in the light guide plate is reduced, and the distribution of the light intensity or luminance along the light guide plate is improved, i.e., a substantially uniform distribution of the light intensity can be achieved.

### FIELD OF THE INVENTION

The invention relates to an illumination apparatus, especially a space divider comprising illumination components.

### BACKGROUND OF THE INVENTION

Light guide plates are widely used in many products, such as LCDs (Liquid Crystal Displays), ultra-thin light boxes and backlights of portable devices, etc. In different applications, the light guide plate cooperates with light sources to fulfill different kinds of illumination requirements.

US2001/0019479 discloses an illuminating system. The illuminating system comprises a linear light source, and a light guide member with the light source placed beside a side face thereof, in which the top face and the bottom face of the light guide member are generally parallel to each other and in which slits made of a different material or air are arranged at specific intervals in the top face of the light guide member. Therefore, most of the light propagating within the light guide member is totally reflected at the slits formed in the light guide member so as to be outputted from the light guide member, thereby illuminating a reflecting plate. The reflected light is incident again on the light guide member and the resulting totally reflected light is transmitted to the observer's side at places other than the slits, while the observer's field of view is not obstructed at the slit portions.

### SUMMARY OF THE INVENTION

Light guide plate can be used as part of a window blind, a screen, a room divider, and a worktable divider, etc, and to provide illumination and/or decoration, while a light source emits light into the light guide plate from one of its surfaces. In some application scenarios, the light guide plate has a considerable length. For example, when the light guide plate is used as a window blind or a curtain, the length of the light guide plate can be 2 meters or even longer.

Due to absorption by the material of the light guide plate and light leakage out of some surfaces, especially side surfaces, of the light guide plate, the light intensity in the areas of the light guide plate far away from the light source is lower than that in the areas near the light source. The non-uniform light intensity distribution in the light guide plate is more severe when the light guide plate is longer. The slits disclosed in US2001/0019479 cannot contribute to reducing the absorption by the material of the light guide plate or light leakage at the side surfaces of the light guide plate.

Considering the above problems found by the inventors of the present invention, it would be advantageous to provide for a substantially or comparatively uniform light distribution in the light guide plate, especially in the areas near the light source and far away from the light source. It would also be desirable to improve the illumination efficiency by decreasing the unwanted light loss caused by material absorption and light leakage.

To better address one or more of the above concerns, there is provided an illumination apparatus according to embodiments of the present invention, the illumination apparatus comprising:

a light guide plate; and

a light source configured to emit light into the light guide plate through a first surface of the light guide plate;

wherein the light guide plate comprises a concentrator configured to direct incident light in the light guide plate so as to radiate in a direction substantially parallel to a preset plane, the preset plane being perpendicular to any one of the top surface and the bottom surface of the light guide plate, and intersecting the first surface and a second surface of the light guide plate or intersecting the first surface and one of the side surfaces of the light guide plate at an angle that is substantially larger than the critical angle of a total reflection.

The basic idea of the present invention is to confine the radiation direction of light within the light guide plate by using a build-in concentrator. When the preset plane is perpendicular to any one of the top surface and the bottom surface of the light guide plate and intersects the first surface and a second surface of the light guide plate, the incident light can radiate in straight lines from the first surface to the second surface and then less incident light is absorbed by the material of the light guide plate. When the preset plane is perpendicular to any one of the top surface and the bottom surface of the light guide plate and intersects the first surface and one side surface of the side surfaces at an angle that is substantially larger than the critical angle of a total reflection, most of the incident light will be totally reflected at the one side surface and less incident light leaks out of the light guide plate, especially at the side surfaces. In this way, unwanted light loss at the side surfaces of the light guide plate is decreased, and hence more incident light can radiate to the place in the light guide plate which is relatively far away from the light source. The distribution of the light intensity or luminance along the light guide plate is improved, i.e., a substantially uniform distribution of the light intensity can be achieved.

These and other aspects of the invention will be apparent from and elucidated with reference to the embodiments described hereinafter.

### DESCRIPTION OF THE DRAWINGS

The above and other objects and features of the present invention will become more apparent from the following detailed description considered in connection with the accompanying drawings, in which:

FIG. 1 (a) to FIG. 1 (c) depict schematic diagrams of top views of embodiments of the illumination apparatus;

FIG. 2 (a) to FIG. 2 (c) depict schematic diagrams of embodiments of a plurality of light reflectors;

FIG. 3 depicts a schematic diagram of a top view of an embodiment of a plurality of light reflectors;

FIG. 4 (a) and FIG. 4 (b) depict schematic diagrams of top views of embodiments of a plurality of light reflectors; and

FIG. 5 (a) and FIG. 5 (b) depict schematic diagrams of top views of embodiments of a plurality of light reflectors.

The same reference numerals are used to denote similar parts throughout the Figures.

### DETAILED DESCRIPTION

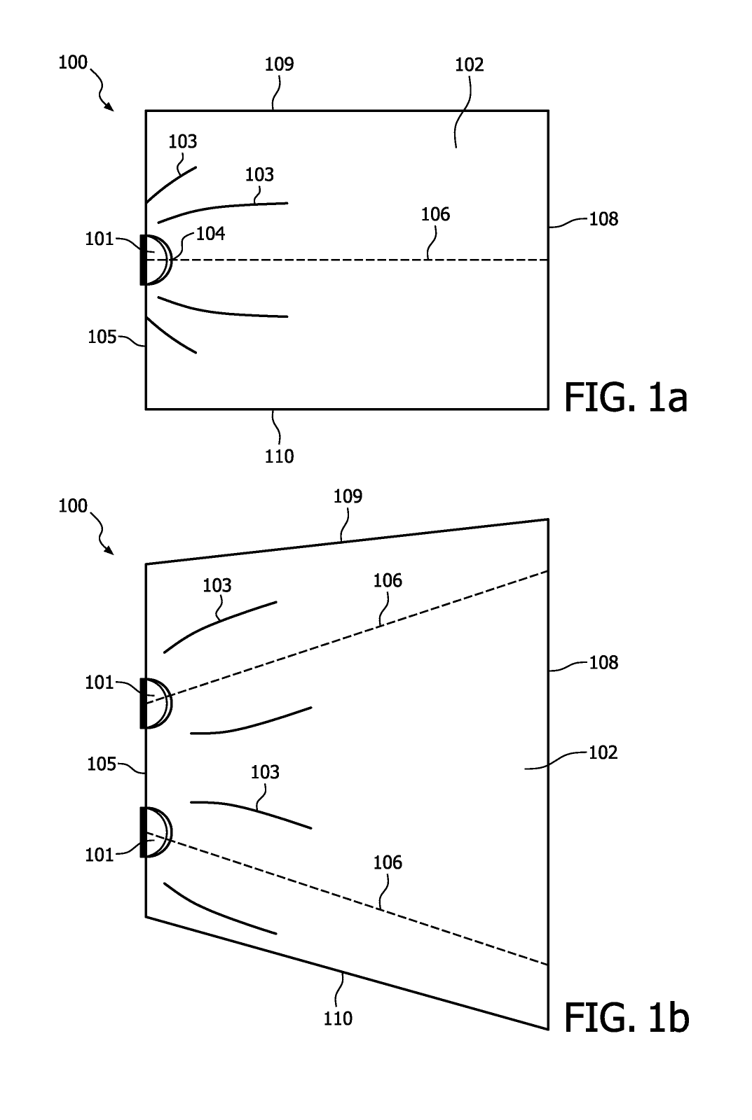

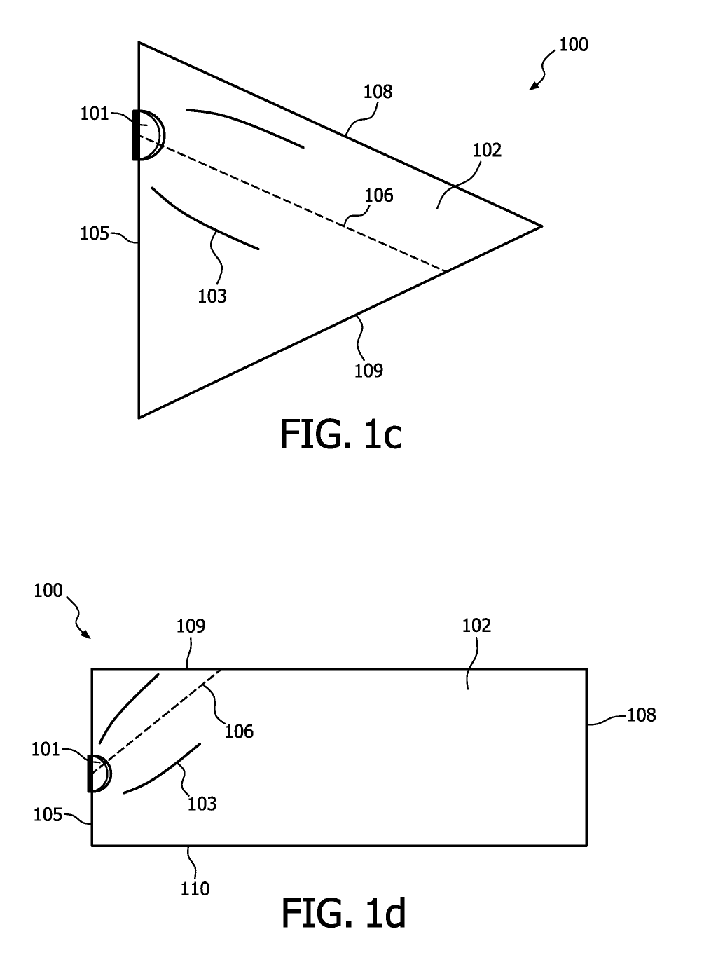

The present invention provides an illumination apparatus. Although the shape of the illumination apparatus is three-dimensional, for the sake of simplicity, most of the Figures in FIG. 1 to FIG. 5 are two-dimensional views of embodiments of the illumination apparatus.

FIG. 1 (a) to FIG. 1 (c) depict schematic diagrams of top views of embodiments of the illumination apparatus.

As shown in FIG. 1 (a), the illumination apparatus 100 comprises a light guide plate 102. The light guide plate 102 is a light conductive plate, which can be made from a material such as quartz, glass, transparent resin like acrylic resin or polycarbonate, or the like. The shape of the light guide plate 102 can be cuboid, trapezoid and triangular as shown respectively in FIG. 1 (a) to FIG. 1 (c), although other regular and irregular shapes are also possible. The light guide plate 102 can be thin or thick.

The illumination apparatus 100 further comprises a light source 101 configured to emit light into the light guide plate 102 through a first surface 105 of the light guide plate 102. The light source 101 can take the form of fluorescent lamps, light emitting diodes, incandescent lamps or organic light-emitting materials.

The light guide plate 102 comprises a concentrator 103 configured to direct incident light in the light guide plate 102 so as to radiate in a direction substantially parallel to a preset plane 106, the preset plane 106 is perpendicular to any one of the top surface (not shown) and the bottom surface (not shown) of the light guide plate 102, and intersects the first surface 105 and a second surface 108 of the light guide plate 102 or intersects the first surface 105 and intersects one of the side surfaces 109, 110 of the light guide plate 102 at an angle that is substantially larger than the critical angle of a total reflection.

The incident light is part or all of the light emitted into the light guide plate 102 by the light source 101. The concentrator 103 is built in the light guide plate 102, and it can be implemented in many ways, for example, as slit(s) in the light guide plate, a setting lens or other kinds of optical elements in the light guide plate.

The top and/or bottom surfaces of the light guide plate 102 are the surfaces where the incident light is configured to radiate out of the light guide plate 102 for illumination and/or decoration. The first surface 105 is the surface through which the light emits into the light guide plane 102, and the second surface 108 is a far surface relative to the first surface. The side surfaces 109, 110 are the side surfaces of the light guide plate 102. In embodiments of the present invention, it is expected that a reduction of light leakage at the side surfaces 109, 110 is achieved.

The preset plane 106 is an artificially defined plane based on the requirement of the incident light propagation direction in the light guide plate 102. The preset plane 106 can be defined in many ways. For example, the preset plane 106 can be a plane parallel to the normal direction of the light source, a plane connecting the near surface of the light guide plate where the light is injected and the far surface opposite to the near surface, or a plane perpendicular to the first surface of the light guide plate where the light is injected.

Referring to FIG. 1 (a), in an embodiment, the two side surfaces 109, 110 of the light guide plate 102 are symmetrical and the preset plane 106 is a plane parallel to the side surfaces 109, 110.

Referring to FIG. 1 (b), in another embodiment, the two side surfaces 109, 110 of the light guide plate 102 are not symmetrical, and the preset planes 106 connect the first surface 105 and the second surface 108.

Referring to FIG. 1 (c), in a further embodiment, the light guide plate 102 is not quadrilateral but trilateral, and the preset plane 106 is a plane intersecting both the first surface 105 and the side surface 109.

Referring to FIG. 1 (d), in a further, different embodiment, the two side surfaces 109, 110 of the light guide plate 102 are symmetrical and the preset plane 106 is a plane intersecting the first surface 105 and the side surface 109 at an angle that is substantially larger than the critical angle of a total reflection.

When the preset plane 106 is perpendicular to any one of the top surface and the bottom surface of the light guide plate 102, and intersects the first surface 105 and a second surface 108 of the light guide plate 102, the incident light can radiate in straight lines from the first surface 105 to the second surface 108, because the incident light in the light guide plate 102 is directed by the concentrator 103 to radiate substantially parallel to the preset plane 106. Therefore, in comparison with free light propagation without the concentrator 103, the incident light's propagation path in the light guide plate 102 is shortened, the light absorption by the material of the light guide plate 102 is decreased, and light leakage at the side surfaces 109, 110 of the light guide plate is reduced. The illumination apparatus 100 in FIG. 1 (a) is taken as an example, in which the incident light, being directed by the concentrator 103, is concentrated so as to radiate in straight lines from the first surface 105 to the second surface 108 of the light guide plate 102 according to the shortest path so as to decrease material absorption and light leakage greatly. Taking the illumination apparatus 100 in FIG. 1 (b) as another example, the incident light radiates from the first surface 105 to the second surface 108 in the areas near the side surfaces 109, 110 of the light guide plate 102, so as to adjust the light distribution in the light guide plate 102 for the aim of illumination and decoration.

When the preset plane 106 is perpendicular to any one of the top surface and the bottom surface of the light guide plate 102 and intersects the first surface 105 and one of the side surfaces 109, 110 at an angle that is substantially larger than the critical angle of a total reflection, the incident light can be directed by the concentrator 103 so as to radiate according to total internal reflection in the light guide plate 102 Taking the illumination apparatus 100 in FIG. 1 (d) as an example, the incident light can radiate from the first surface 105 of the light guide plate 102 to the second surface 108 of the light guide plate 102 according to total internal reflection on the side surfaces 109, 110 of the light guide plate 102. In this way, there is less or no light leakage on the side surfaces 109, 110, so that more light can radiate from the first surface 105 of the light guide plate 102 to the second surface 108 of the light guide plate 102.

More advantages can be achieved by adjusting the setting of the light source 101.

By placing the light source 101 at the preset plane 106, the incident light directed by the concentrator 103 can be symmetrical relative to the preset plane 106, and the light distributes more evenly in the light guide plate 102.

By setting an indentation 104 matching the shape of and being coupled to the light source 101 in the light guide plate 102, and placing the light source 101 at the indentation 104 as shown in FIG. 1 (a), less light is reflected from the surface of the indentation 104 and more light enters the light guide plate 102. In this way, the illumination efficiency is improved. The shape of the indentation will be different for light sources of different shapes. For example, the indentation is in the shape of a relatively big ball when the light source is in the shape of a relatively big ball; the shape of the indentation is relatively shallow and small when the shape of the light source is relatively flat and small.

In an embodiment of the concentrator 103, the concentrator 103 comprises a plurality of light reflectors.

The plurality of light reflectors can be implemented in many ways. For example, each light reflector comprises a slit. The slit is easy to implement in many ways, for example, the slit can be cut in the light guide plate by laser. The slit is partly or wholly filled with air and/or a material having a refractive index lower than the refractive index of the light guide plate. In this way, when the angle of incidence of the light is large enough, the light can be totally reflected by the slit. If the refractive index difference between the refractive indexes of the filling material and the light guide plate is not large enough, the slit can be partly or wholly coated with a reflective coating. Reflective coating materials can be aluminum and silver, etc.

According to a rule of thumb formula, the evanescent wave coupling will not be an issue when the width of the slit is larger than ten times the wavelength of the light. It means that the light can be totally reflected by the slits if the angle of incidence fulfills the requirement of a total reflection. In addition, when the slit intersects the edge of the light guide plate, if the width of the slit is very large, there will be light in the light guide plate escaping from the slit to the outside. Therefore, it is desirable for the width of the slit α to satisfy 0.01 mm≦α≦1 mm.

Each light reflector can be in the shape of a segment of a parabola, a straight line, a segment of an ellipse, a segment of a hyperbola or a segment of a circle, etc.

When a light reflector is in the shape of a straight line, the light direction reflected by the straight-line-shaped light reflector can be controlled by setting the inclination angle of the light reflector relative to one side of the light guide plate.

When a light reflector is in the shape of a segment of a parabola, the light source can be placed on the focal point of the parabola-shaped light reflector so that the light reflected by the light reflector is substantially parallel. It is also possible to concentrate the incident light if the focal point of the parabola-shaped light reflector does not overlap with the light source.

Light reflectors in different shapes can cooperate with each other to control the radiation direction of the light reflected by the light reflectors.

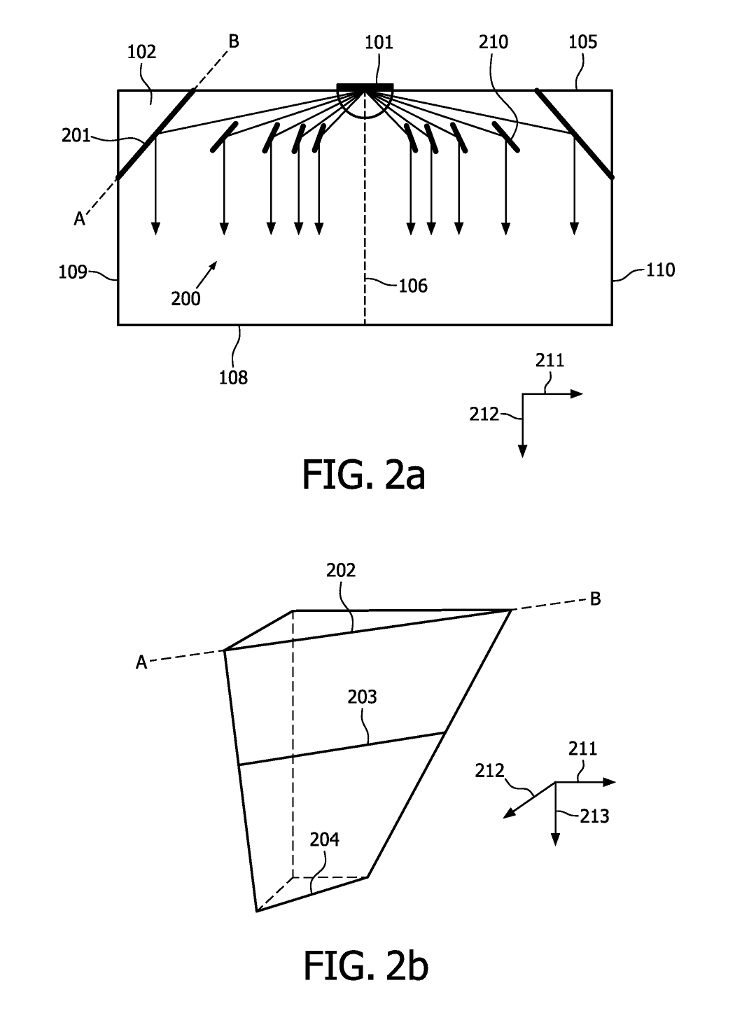

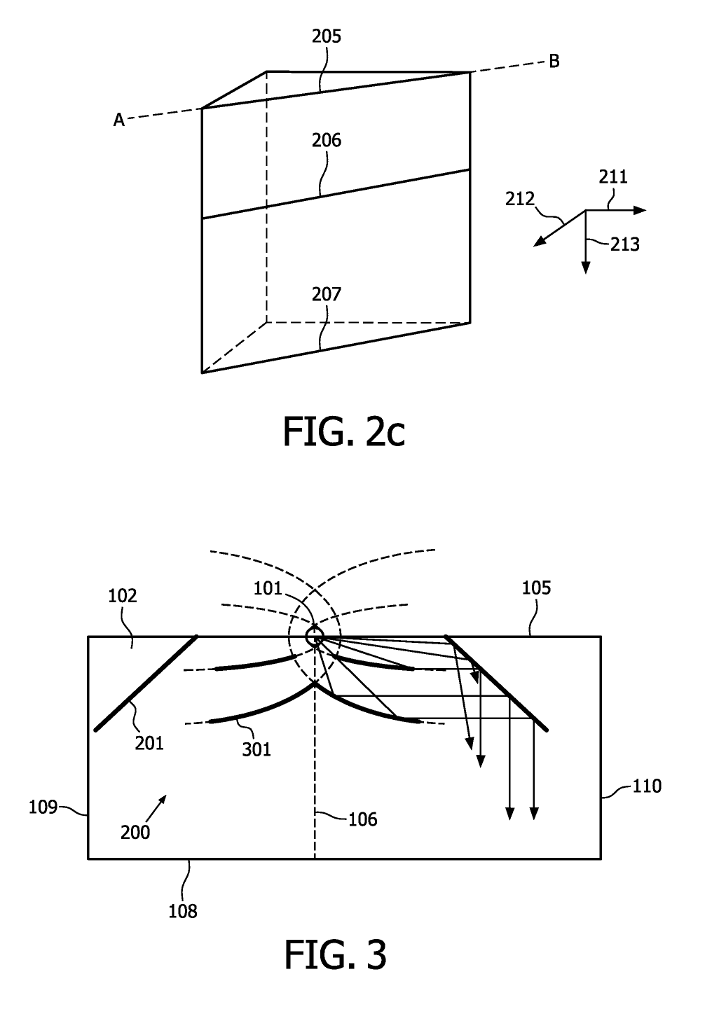

Referring to FIG. 2 to FIG. 5, several embodiments of the plurality of reflectors 200 are described as follows.

FIG. 2 (a) to FIG. 2 (c) depict schematic diagrams of embodiments of a plurality of light reflectors 200.

Referring to FIG. 2 (a), in an embodiment of the plurality of light reflectors 200, the plurality of light reflectors 200 comprise a plurality of straight-line-shaped light reflectors 201 all having different inclination angles. Each straight-line-shaped light reflector 201 with a specific inclination angle can direct the incident light reflected by the straight-line-shaped light reflector 201 so as to extend substantially parallel to the preset plane 106.

Short straight-line-shaped light reflectors 201 can also work well by increasing the number of the straight-line-shaped light reflectors 201 and arranging these straight-line-shaped light reflectors 201 along the width of the light guide plate 102. Compared with the area occupied by long straight-line-shaped light reflectors 201, the area occupied by short straight-line-shaped light reflectors 201 is relatively small. It is advantageous to place light reflectors 200 in the relatively narrow area near the light source 101. It is easy to hide the area comprising the concentrator 103 from a user's view, which also helps improve the aesthetics of the final product, e.g., a window blind.

FIG. 2 (a) is a two-dimensional view of the straight-line-shaped light reflectors 201, taken from the direction perpendicular to the plane of the x-axis 211 and the y-axis 212. To illustrate the three-dimensional view of the straight-line-shaped light reflectors 201, FIG. 2 (b) shows a cross sectional view of the straight-line-shaped light reflector 201 in the top left corner in FIG. 2 (a) by looking from the direction perpendicular to the line AB in FIG. 2 (a). Three three-dimensional views of the straight-line-shaped light reflector 201 in the top left corner in FIG. 2 (a) taken along the z-axis 213 are shown in FIG. 2 (b). They are the first view 202, the second view 203 and the third view 204. It can be found that the length of the straight-line-shaped light reflector 201 in the top left corner in FIG. 2 (a) varies in these three dimensional views. The length of the straight-line-shaped light reflector 201 in the top left corner in FIG. 2 (a) can also be the same in the three dimensional views taken along the z-axis 213, i.e. the three views 205, 206 and 207 shown in FIG. 2 (c). For other shapes of the light reflector 200, the three-dimensional view of the light reflector 200 which is not illustrated in the other Figures can be the same or different seen in a three-dimensional direction. The depth of the light reflectors 200 can be the same as the depth of the light guide plate 102 or shorter than the depth of the light guide plate 102.

FIG. 3 depicts a schematic diagram of a top view of another embodiment of the plurality of reflectors 200.

Referring to FIG. 3, in another embodiment of the plurality of light reflectors 200, the plurality of light reflectors 200 comprise a plurality of light reflector pairs, each light reflector pair comprising two light reflectors 200 symmetrically arranged relative to the preset plane 106. The plurality of light reflector pairs can all have the same shape, such as a straight line; or have different shapes, for example, as shown in FIG. 3, each light reflector 301 of two light reflector pairs is in the shape of a segment of a parabola and each light reflector 201 of a light reflector pair is in the shape of a straight line.

In a pair of curve-shaped light reflectors 200, as long as the two light reflectors 200 of a pair are symmetrical, the two light reflectors 200 can be in the shape of segments of a same curve or different curves. For example, when the light reflector pair is in the shape of a segment of a parabola, two light reflectors 200 in the light reflector pair can be in the shape of the same segment of the same parabola or in the shape of two different segments of two different parabolas.

The light reflector pairs can be different in layout. For example, a light reflector 200 intersects the first surface 105 of the light guide plate 102 where the incident light enters. In FIG. 3, the straight-line-shaped light reflectors 201 intersect the first surface 105. In this way, all of the incident light can be reflected by the concentrator 103, so that there is less unwanted light leakage. It is possible for all or part of the light reflectors 200 to intersect the first surface 105.

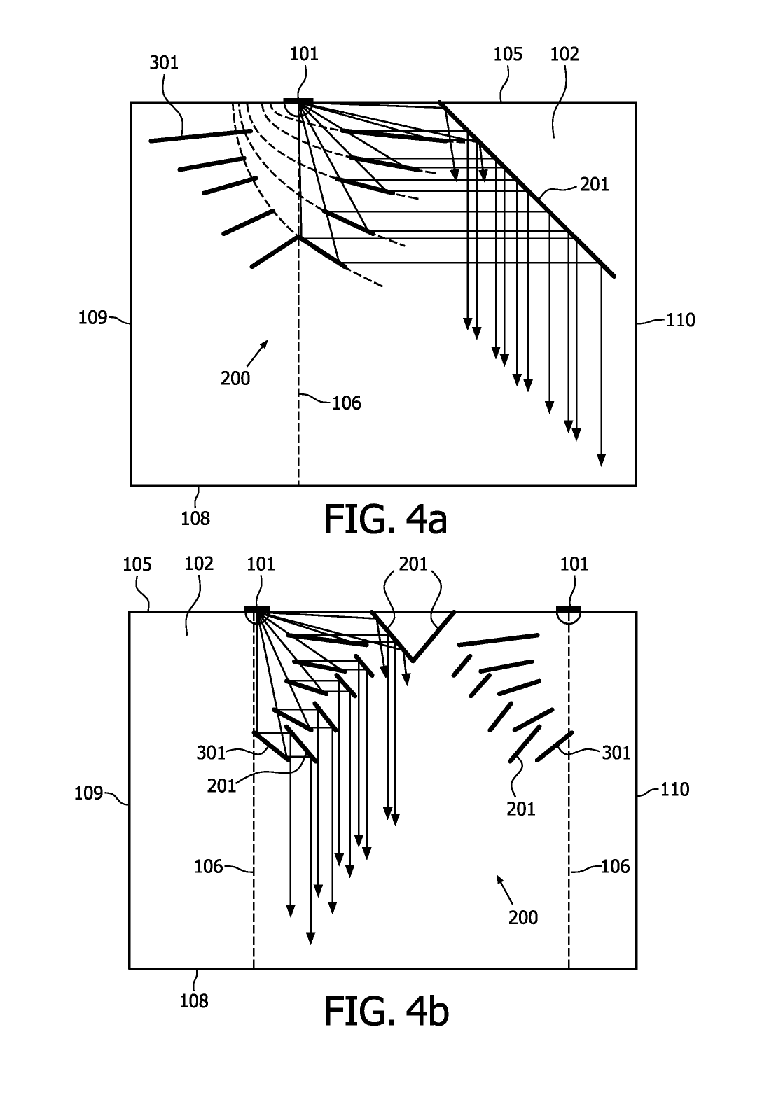

FIG. 4 (a) and FIG. 4 (b) depict schematic diagrams of top views of embodiments of a plurality of light reflectors 200.

In a further embodiment of the plurality of light reflectors 200, the plurality of light reflectors 200 comprise a plurality of parabola-shaped light reflectors 301 and a plurality of straight-line-shaped light reflectors 201, each parabola-shaped light reflector 301 having the parabola axis plane perpendicular to the preset plane 106 and the focal point overlapping with the light source 101, and each straight-line-shaped light reflector 201 being configured to reflect the light reflected from the plurality of parabola-shaped light reflector 301 in the direction parallel to the preset plane 106.

By making sure that the focal point and the light source 101 demonstrate an overlap, the plurality of parabola-shaped light reflectors 301 make the incident light propagate substantially parallel in the light guide plate 102. Then the plurality of straight-line-shaped light reflectors 201 is configured to redirect the radiation direction of the light reflected by the parabola-shaped light reflectors 301. In this way, the area of the light reflectors 200 for changing the radiation direction of the incident light can be small. It is advantageous to place light reflectors 200 in the relatively narrow area near the light source 101. It is easy to hide the area comprising the concentrator 103 from a user's view, which also helps improve the aesthetics of the final product, e.g., a window blind.

The arrangement for coupling the plurality of parabola-shaped light reflectors 301 and the plurality of straight-line-shaped light reflectors 201 can be implemented in many ways.

Taking the light reflectors 200 in FIG. 4 (a) as an example, one straight-line-shaped light reflector 201 is configured to couple to five parabola-shaped light reflectors 301. In this way, the layout of the reflectors 200 is easy to implement because only one straight-line-shaped light reflector 201 is needed to couple five parabola-shaped light reflectors 301.

Taking the light reflectors 200 in FIG. 4 (b) as another example, each straight-line-shaped light reflector 201 is further configured to couple to a corresponding parabola-shaped light reflector 301 among the plurality of parabola-shaped light reflectors 301 to reflect the light reflected from said parabola-shaped light reflector 301 in a direction parallel to the preset plane 106. For example, five straight-line-shaped light reflectors 201 are configured to couple to five parabola-shaped light reflectors 301. As there are straight-line-shaped light reflectors 201 coupling to the parabola-shaped light reflectors 301 near the preset plane 106, a comparison with the embodiment shown in FIG. 4 (a) shows that there is more reflected light in the area near the preset plane 106 in FIG. 4 (b). Consequently, the incident light distributes more uniformly from the centre to the border of the concentrator 103.

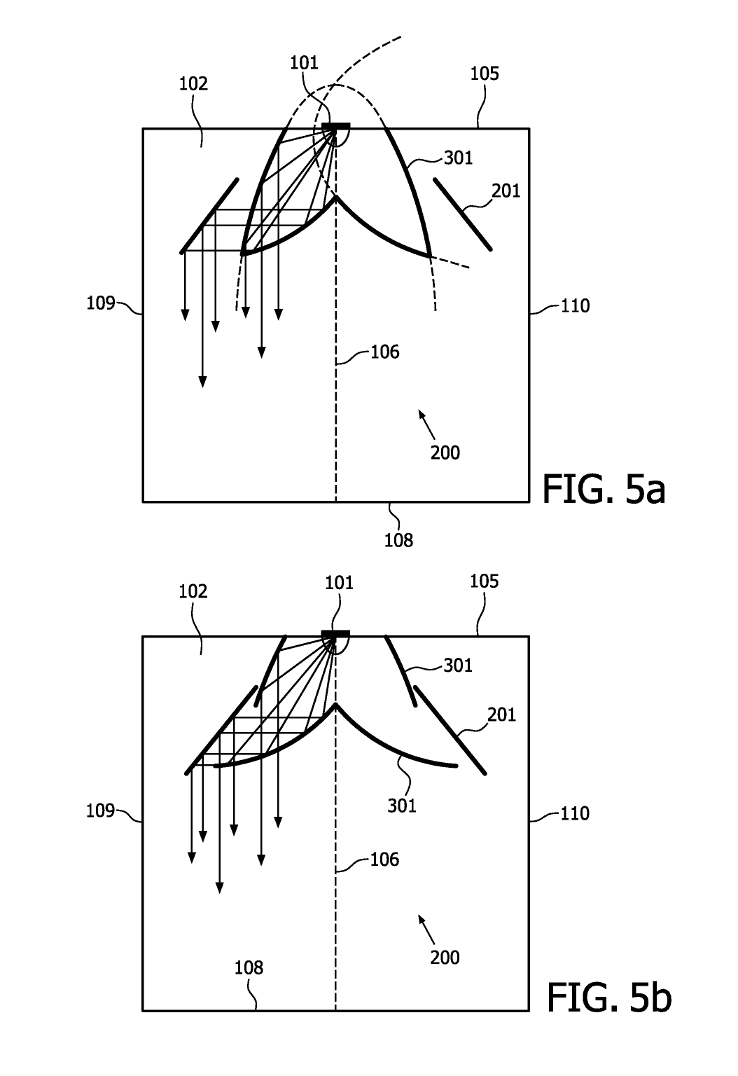

FIG. 5 (a) and FIG. 5 (b) depict schematic diagrams of top views of embodiments of a plurality of light reflectors.

Referring to FIG. 5 (a) and FIG. 5 (b), in a further embodiment of the plurality of light reflectors 200, the plurality of light reflectors 200 comprise two pairs of parabola-shaped light reflectors 301 and a pair of straight-line-shaped light reflectors 201. Each parabola-shaped light reflector 301 of a pair of parabola-shaped light reflectors 301 has the parabola axis plane parallel to the preset plane 106 and the focal point overlapping with the light source 101; and each parabola-shaped light reflector 301 of another pair of parabola-shaped light reflectors 301 has the parabola axis plane perpendicular to the preset plane 106 and the focal point overlapping with the light source 101. The pair of straight-line-shaped light reflectors 201 is configured to correspondingly couple to the pair of parabola-shaped light reflectors 301 whose parabola axis plane is perpendicular to the preset plane 106. The parabola-shaped light reflectors 301 are transparent to the light when the angle of incidence of the light radiating on the parabola-shaped light reflectors 301 is very small, i.e. the light is not reflected by parabola-shaped light reflectors 301.

As shown in FIG. 5 (a) and FIG. 5 (b), only six light reflectors 200 are needed to effectively direct the incident light so as to radiate in a direction substantially parallel to the preset plane 106. Therefore, the implementation of the light reflectors 200 is very simple and easy. In addition, the area of light reflectors 200 for changing the radiation direction of the incident light can be small. It is advantageous to place light reflectors 200 in the relatively narrow area near the light source 101. It is easy to hide the area comprising the concentrator 103 from a user's view, which also helps improve the aesthetics of the final product, e.g., a window blind.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the apparatus claims enumerating several units, several of these units can be embodied by one and the same item of hardware or software. The usage of the words first, second and third, et cetera, does not indicate any ordering. These words are to be interpreted as names.

1. An illumination apparatus comprising:
a light guide plate; and
a light source configured to emit light into the light guide plate through a first surface of the light guide plate;
wherein the light guide plate comprises a concentrator configured to direct incident light in the light guide plate so as to radiate substantially in a direction parallel to a preset plane, the preset plane being perpendicular to any one of the top surface and the bottom surface of the light guide plate and intersecting the first surface and a second surface of the light guide plate or intersecting the first surface and one of the side surfaces of the light guide plate at an angle that is substantially larger than the critical angle of a total reflection.

2. An illumination apparatus as claimed in claim 1, wherein the concentrator comprises a plurality of light reflectors.

3. An illumination apparatus as claimed in claim 2, wherein each light reflector comprises a slit.

4. An illumination apparatus as claimed in claim 3, wherein at least a portion of the slit is filled a material having a refractive index lower than the refractive index of the light guide plate.

5. An illumination apparatus as claimed in claim 3, wherein the width of the slit is greater or equal to 0.01 mm and less than or equal to 1 mm.

6. An illumination apparatus as claimed in claim 2, wherein each light reflector is in the shape of a segment of a parabola, a straight line, a segment of an ellipse, a segment of a hyperbola or a segment of a circle.

7. An illumination apparatus as claimed in claim 2, wherein the plurality of light reflectors comprises a plurality of light reflector pairs, each light reflector pair comprising two light reflectors symmetrically arranged relative to the preset plane.

8. An illumination apparatus as claimed in claim 2, wherein a light reflector among the plurality of light reflectors intersects the first surface of the light guide plate.

9. An illumination apparatus as claimed in claim 2, wherein the plurality of light reflectors comprise a plurality of straight-line-shaped light reflectors having inclination angles which are different from each other.

10. An illumination apparatus as claimed in claim 2, wherein the plurality of light reflectors comprise a plurality of parabola-shaped light reflectors and a plurality of straight-line-shaped light reflectors, each parabola-shaped light reflector having the parabola axis plane perpendicular to the preset plane and the focal point overlapping with the light source, each straight-line-shaped light reflector being configured to reflect the light reflected from the plurality of parabola-shaped light reflectors in the direction parallel to the preset plane.

11. An illumination apparatus as claimed in claim 10, wherein each straight-line-shaped light reflector is further configured to couple to one corresponding parabola-shaped light reflector among the plurality of parabola-shaped light reflectors to reflect the light reflected from the one parabola-shaped light reflector in a direction parallel to the preset plane.

12. An illumination apparatus as claimed in claim 10, wherein the plurality of light reflectors further comprises a pair of parabola-shaped light reflectors, each parabola-shaped light reflector having the parabola axis plane parallel to the preset plane of the concentrator and the focal point overlapping with the light source.

13. An illumination apparatus as claimed in claim 1, wherein the light source is placed at an indentation of the light guide plate, the shape of the indentation matching the shape of and being coupled to the light source.

14. An illumination apparatus as claimed in claim 3, wherein at least a portion of the slit is or filled with air.
